(19) United States
(12) Patent Application Publication
(10) Pub. No.: US 2026/0291681 A1
(43) Pub. Date: Sep. 24, 2026

(54) TRANSMISSION CONFIGURATION INDICATOR (TCI) FRAMEWORK BASED ON FREQUENCY-DEPENDENT BEAM MEASUREMENT AND REPORTING

(71) Applicant: InterDigital Patent Holdings, Inc., Wilmington, DE (US)

(72) Inventors: Jonghyun Park, Syosset, NY (US); Afshin Haghighat, Ile-Bizard (CA); Moon IL Lee, Melville, NY (US); Omid Saatlou, Montreal (CA); Loic Canonne-Velasquez, Dorval (CA); Mohammad Irfan, Chateauguay (CA); Virgil Comsa, Montreal (CA)

(73) Assignee: InterDigital Patent Holdings, Inc., Wilmington, DE (US)

(21) Appl. No.: 19/088,135

(22) Filed: Mar. 24, 2025

(51) Int. Cl. H04L 5/00

(52) U.S. Cl. CPC H04L 5/005; H04L 5/0091

(57) ABSTRACT

Methods, systems, and apparatuses for transmission configuration indicator (TCI) framework based on frequency-dependent beam measurement and reporting is provided. A wireless transmit/receive unit (WTRU) may receive a configuration of a plurality of TCI states and a plurality of downlink (DL) reference signal (RS) resources. The WTRU may determine a first receive (Rx) beam for measuring a first DL RS resource of the plurality of DL RS resources. The WTRU may performing one or more measurements on a plurality of subbands (SBs) associated with the first DL RS resource. The WTRU may determine a subband-based Rx beam associated with a SBs to be used for communicating with the base station.

### BACKGROUND

In fifth generation (5G) wireless communication systems, a network may use an analog beam for a given time unit (e.g., symbol, slot) for downlink transmission. Conventionally, the network may utilize one or more phase-shifters to generate a frequency flat response. This results in the downlink transmission being beamformed toward an intended beam direction. For enhanced analog beamforming, a joint phase-time array (JPTA) method may be considered as opposed to only using one or more phase offsets such as the one or more phase-shifters generating one analogue beam direction. The JPTA may allow generation of multiple frequency-dependent analog beams to be used for downlink transmission at the same time.

### SUMMARY

In one or more embodiments, a method performed by a wireless transmit/receive unit (WTRU) is provided. The method includes receiving, from a base station, configuration information indicative of a plurality of transmission configuration indication (TCI) states and a plurality of downlink (DL) reference signal (RS) resources. The method includes performing, using a first Rx beam, one or more measurements on a plurality of subbands (SBs) associated with the first DL RS resource of the plurality of DL RS resources. The method includes selecting a set of SBs, from the plurality of SBs associated with a first DL RS resource, based at least on the one or more measurements. The method includes transmitting, to the base station, a first indication of a set of subband tags (SBTs) associated with the selected set of SBs. The method includes determining a set of subband-based Rx beams associated with the selected set of SBs. The method includes associating the set of subband-based Rx beams to a first TCI state of the plurality of TCI states. The method includes receiving, from the base station, a second indication indicating that the WTRU is to use the first TCI state and at least one SBT of the set of SBTs. The method includes communicating with the base station using at least one of the set of subband-based Rx beams associated with the first TCI state and the at least one SBT.

In an embodiment, the configuration information comprises one or more of: an indication that the each DL RS resource is applicable for frequency-dependent beam measurement (BM) and reporting, an indication of one or more SBs and one or more corresponding SBTs associated with the each DL RS, or an indication of one or more quasi colocation linked (QCL-linked) RSs associated with the plurality of DL RS resources.

In an embodiment, the method comprises measuring a first QCL-linked RS of the one or more QCL-linked RSs associated with the first DL RS resource. The method comprises determining the first Rx beam based on the measured first QCL-linked RS.

In an embodiment, selecting the set of SBs comprises: comparing the one or more measurements with one or more thresholds; and selecting the set of SBs corresponding to the one or more measurements exceeding the one or more thresholds.

In an embodiment, communicating with the base station comprises: receiving, based on the second indication, at least one of: a DL signal or a DL channel scheduled on at least one SB associated with the at least one SBT.

In an embodiment, communicating with the base station comprises: transmitting, based on the second indication, at least one of: a uplink (UL) signal or a UL channel scheduled on at least one SB associated with the at least one SBT.

In an embodiment, the first indication comprises a request to perform beam sweeping. The set of subband-based Rx beams are determined based at least on the first indication. The set of subband-based Rx beams are narrower than the first Rx beam.

In an embodiment, the method includes determining a default SBT from the at least one SBT.

In an embodiment, the method includes applying a beam cycling across the at least one SBT.

In an embodiment, the method includes determining at least one of: a valid DL signal, a DL channel, a UL signal, or a UL channel within the an SB corresponding to the default SBT.

In one or more embodiments, a WTRU comprising a transceiver and a processor is provided. The transceiver and the processor are configured to receive, from a base station, configuration information of a plurality of TCI states and a plurality of DL RS resources. The transceiver and the processor are configured to perform, using a first Rx beam, one or more measurements on a plurality of SBs associated with a first DL RS resource of the plurality of DL RS resources. The transceiver and the processor are configured to select a set of SBs, from the plurality of SBs associated with the first DL RS resource, based at least on the one or more measurements. The transceiver and the processor are configured to transmit, to the base station, a first indication of a set of SBTs associated with the selected set of SBs. The transceiver and the processor are configured to determine a set of subband-based Rx beams associated with the selected set of SBs. The transceiver and the processor are configured to associate the set of subband-based Rx beams to a first TCI state of the plurality of TCI states. The transceiver and the processor are configured to receive, from the base station, a second indication for using the first TCI state and at least one SBT of the set of SBTs. The transceiver and the processor are configured to communicate with the base station using at least one of the set of subband-based Rx beams associated with the first TCI state and the at least one SBT.

In an embodiment, the configuration information comprises one or more of: an indication that the each DL RS resource is applicable for frequency-dependent BM and reporting, an indication of a set of SBs and corresponding set of SBTs associated with the each DL RS, or an indication of one or more QCL-linked RSs associated with the plurality of DL RS resources.

In an embodiment, the transceiver and the processor are configured to measure a first QCL-linked RS of the one or more QCL-linked RSs associated with the first DL RS resource, and determining the first Rx beam based on the measured first QCL-linked RS.

In an embodiment, wherein selecting the set of SBs comprises: comparing the one or more measurements with one or more thresholds, and selecting the set of SBs corresponding to the one or more measurements exceeding the one or more thresholds.

In an embodiment, communicating with the base station comprises: receiving, based on the second indication, at least one of: a DL signal or a DL channel scheduled on at least one SB associated with the at least one SBT.

In an embodiment, communicating with the base station comprises: transmitting, based on the second indication, at least one of: a UL signal or a UL channel scheduled on at least one SB associated with the at least one SBT.

In an embodiment, the first indication comprises a request to perform beam sweeping. The set of subband-based Rx beams are determined based at least on the first indication. The set of subband-based Rx beams are narrower than the first Rx beam.

In an embodiment, the transceiver and the processor are further configured to: determine a default SBT from the at least one SBT.

In an embodiment, the transceiver and the processor are further configured to: applying a beam cycling across the at least one SBT.

In an embodiment, the transceiver and the processor are further configured to determine at least one of: a valid DL signal, a DL channel, a UL signal, or a UL channel within an SB corresponding to the default SBT.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an illustration of an example transmission configuration indication (TCI) field in a downlink control information (DCI) according to one or more embodiments;

FIG. 3 illustrates an example of one or more synchronization signals associated with multiple subbands is shown according to one or more embodiments;

FIG. 4 illustrates an example of one or more synchronization signals associated with multiple subbands is shown according to one or more embodiments; and

FIGS. 5A-5B are a flowchart illustrating an example method for a frequency-dependent analog beamforming operation according to one or more embodiments.

### DETAILED DESCRIPTION

The following non-exhaustive list of abbreviations in Table 1 may be used in this disclosure:

TABLE 1

| | |
|---|---|
| CG | Configured grant |
| DG | Dynamic grant |
| MAC CE | MAC control element |
| ACK | Acknowledgement |
| BLER | Block Error Rate |
| BWP | Bandwidth Part |
| C-JT | Coherent Joint Transmission |
| CP | Cyclic Prefix |
| CP-OFDM | Conventional OFDM (relying on cyclic prefix) |
| CQI | Channel Quality Indicator |
| CRC | Cyclic Redundancy Check |
| CSI | Channel State Information |
| DAI | Downlink Assignment Index |
| DCI | Downlink Control Information |
| DL | Downlink |
| DM-RS | Demodulation Reference Signal |
| DRB | Data Radio Bearer |
| HARQ | Hybrid Automatic Repeat Request |
| LTE | Long Term Evolution e.g. from 3GPP LTE R8 and up |
| NACK | Negative ACK |
| mTRP | Multiple TRP |
| MCS | Modulation and Coding Scheme |
| MIMO | Multiple Input Multiple Output |
| NC-JT | Non-Coherent Joint Transmission |
| NR | New Radio |
| OFDM | Orthogonal Frequency-Division Multiplexing |
| PHY | Physical Layer |
| PMI | Precoding Matrix Indicator |
| PRACH | Physical Random Access Channel |
| PSS | Primary Synchronization Signal |
| RACH | Random Access Channel (or procedure) |
| RAR | Random Access Response |
| RF | Radio Front end |
| RLF | Radio Link Failure |
| RLM | Radio Link Monitoring |
| RNTI | Radio Network Identifier |
| RRC | Radio Resource Control |
| RRM | Radio Resource Management |
| RS | Reference Signal |
| RSRP | Reference Signal Received Power |
| RSSI | Received Signal Strength Indicator |
| SDU | Service Data Unit |
| SRS | Sounding Reference Signal |
| SS | Synchronization Signal |
| SSS | Secondary Synchronization Signal |
| SPS | Semi-persistent scheduling |
| SUL | Supplemental Uplink |
| TB | Transport Block |
| TBS | Transport Block Size |
| TRP | Transmission/Reception Point |
| UL | Uplink |
| URLLC | Ultra-Reliable and Low Latency Communications |
| WLAN | Wireless Local Area Networks and related |
| | technologies (IEEE 802.xx domain) |

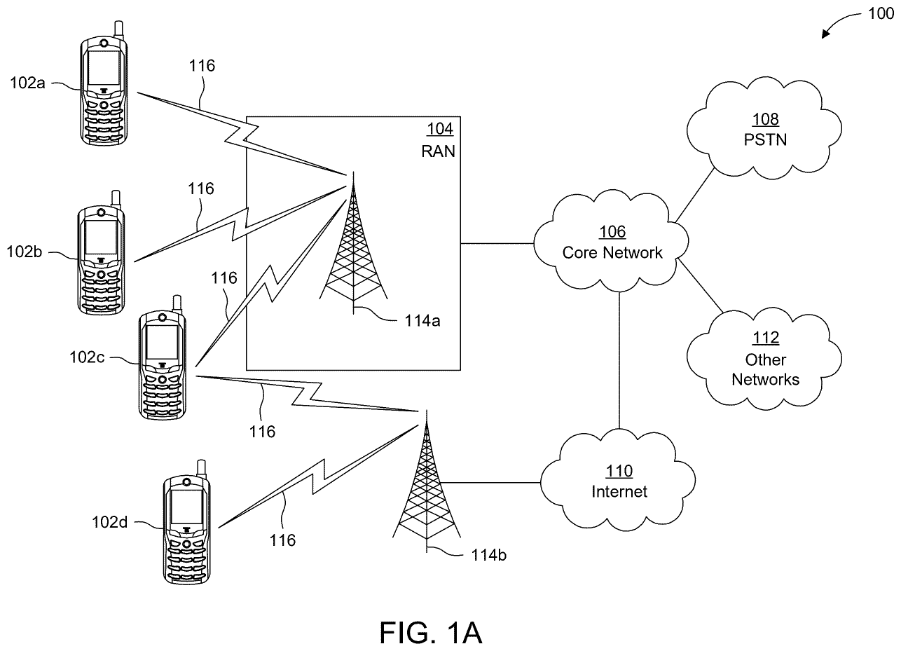

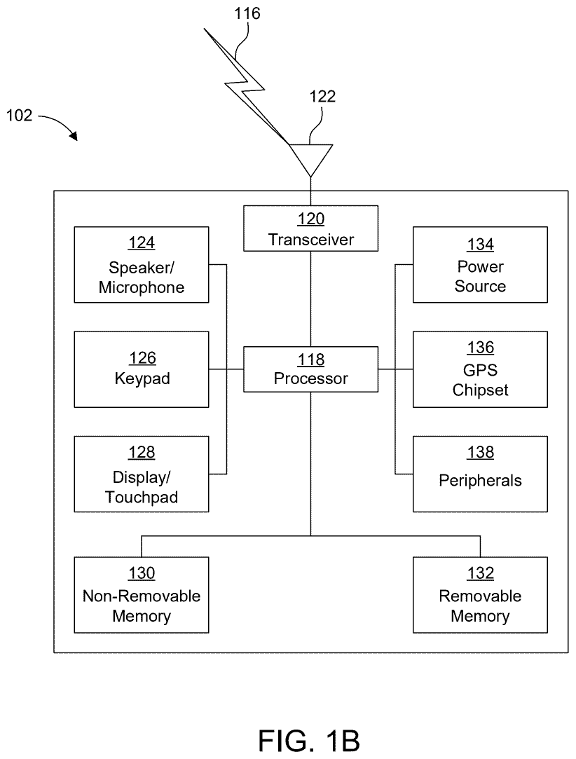

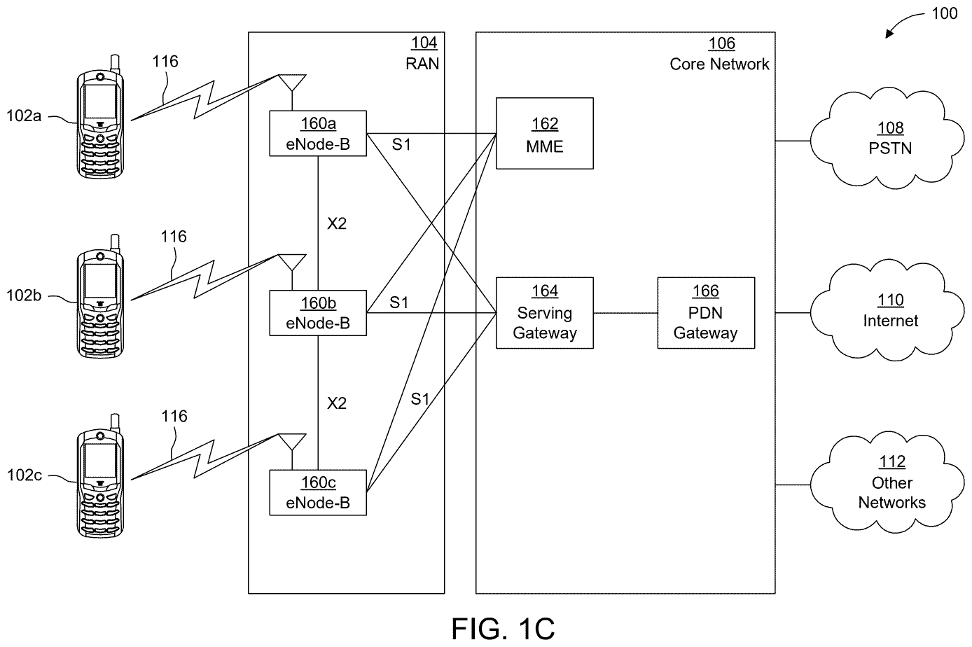

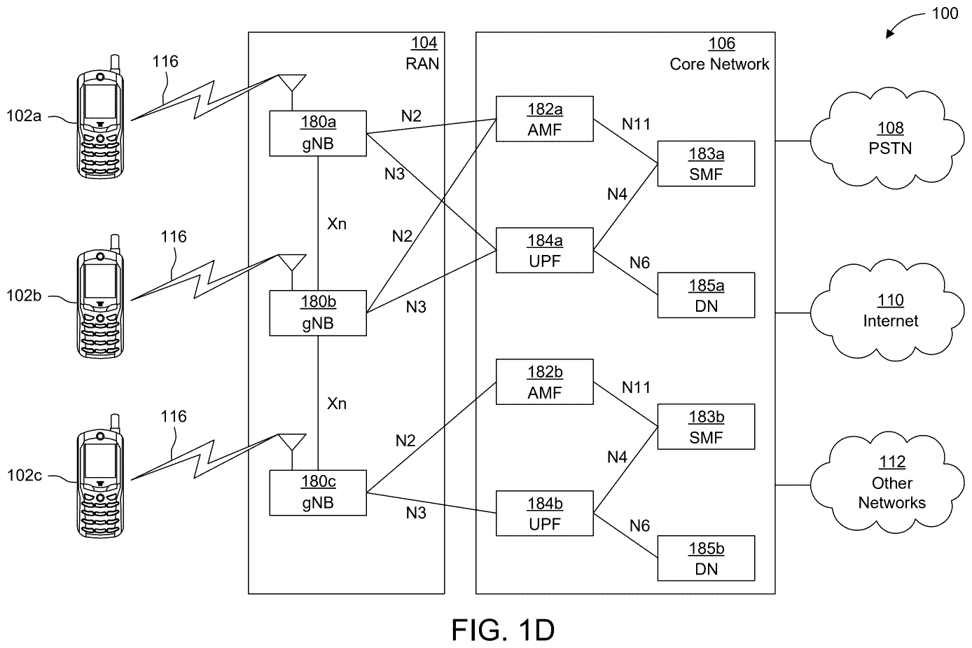

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In various embodiments of the present disclosure, methods, systems, and devices are provided for frequency-dependent beam measurement and/or reporting and associated transmission configuration indicator (TCI)-state indication. In an embodiment, a method performs frequency-dependent beam measurement and/or reporting using narrower beam on top of quasi co-location (QCL) ed wider beam reference. The method uses a TCI state configured with an reference signal (RS) resource and at least one subband tag (SBT). The method performs an operation based on a default SBT and dynamic resource assignment across multiple SBTs. The method includes beam cycling across SBTs for measurements or data reception.

In 5G NR systems, a network may use one analog beam for a given time unit (e.g., a symbol, a slot etc.) for a downlink transmission, e.g., synchronization signal block (SSB), downlink reference signal (DL RS), physical downlink control channel (PDCCH), physical downlink channel (PDSCH) by using one or more phase-shifters as a part of one or more analog components which generate a frequency flat response, resulting in the downlink transmission being beamformed toward an intended beam direction, e.g., in frequency range (FR2).

A joint phase-time array (JPTA) method may be considered as an enhanced analog beamforming technique using one or more true time delays (TDDs) as opposed to only using one or more phase offsets such as the one or more phase-shifters generating one analogue beam direction. The JPTA allows generation of multiple frequency-dependent analog beams to be used for downlink transmission at the same time.

In various embodiments of the present disclosure, one or more methods are provided for controlling beam management procedure of a wireless transmit/receive unit (WTRU) based on a JPTA operation. One or more methods for controlling frequency-dependent resource allocation and management for data communication, based on the JPTA operation, also in consideration of dynamic traffic condition change are also provided in various embodiments.

In an embodiment, a method performs frequency-dependent beam measurement and/or reporting and associated TCI-state indication.

A WTRU may receive configuration of a plurality of TCI-states and a plurality of DL RS (e.g., channel state information reference signal (CSI-RS)) resources. A DL RS resource (e.g., each or any DL resource) of the plurality of DL RS resources may be associated with at least one of configuration parameter and/or property. In an example, a DL RS resource may be associated with an indication that the DL RS resource is applicable for frequency-dependent (e.g., JPTA-based) beam measurement (BM) and reporting. In an example, a DL RS resource may be associated with information indicating a number of subbands (SBs) associated with the DL RS, each corresponding to an SBT ID. For example, the size of each SB may be equal to the bandwidth of the DL RS resource divided by the number of SBs or the size of each SB is configured by the network. In an example, a DL RS resource may be associated with information on a QCL-linked RS, e.g., a source QCL RS, of the DL RS resource, where the QCL-linked RS may be an SSB and/or a tracking RS (TRS).

Each of one or more TCI-states of the plurality of TCI-states may be, respectively, associated with at least one SBT (or SB) and a DL RS resource of the plurality of DL RS resources. For example, TCI state 1 may be associated with (DL RS resource 1, SBT 1); TCI state 2 may be associated with (DL RS resource 1, SBT 2); TCI state 3 may be associated with (DL RS resource 1, SBT 3, SBT 4); TCI state 4 may be associated with (DL RS resource 2, SBT 1) etc., for example.

A TCI-state that is associated with at least one SBT (or SB) may represent a narrower beam within (or across) the at least one SBT (or SB).

A TCI-state that is not associated with any SBT (or SB) may represent a wider beam across all SBTs (or SBs).

The WTRU may measure the QCL-linked RS (e.g., the source QCL RS such as the SSB and/or tracking reference signal (TRS) etc.) associated with a first DL RS resource of the plurality of DL RS resources, and determines a first Rx beam (e.g., spatial-domain filter, representing a wider beam) to be used for measuring the first DL RS resource across SBs.

The WTRU may perform multiple (separate) measurements on the first DL RS resource.

In an example, each measurement of the multiple measurements may be conducted for an SB (e.g., a different SB) of the SBs configured for the first DL RS resource where each measurement is performed using the first Rx beam.

The WTRU may perform a measurement for each SB of the configured SBs for the first DL RS resource

The WTRU may select one or more SBs of the measured SBs based on a configured measurement metric (e.g., layer1 (L1)-reference signal received power (RSRP), L1-signal to interference noise ratio (SINR), channel quality indicator (CQI), according to reportQuantity etc.) and one or more thresholds (e.g., configured and/or indicated thresholds); for example, the WTRU selects the one or more SBs for which the corresponding measurement exceeds the threshold.

The WTRU may report one or more SBTs (e.g., the SBT(s) corresponding to the one or more selected SB(s) and, optionally, one or more determined measurement metrics corresponding to the one or more SBTs.

The WTRU may determine an SB-based Rx beam for at least one of the SBs associated with the first DL resource. For example, the WTRU determines an SB-based Rx beam for each of the selected one or more SBs

Each SB-based Rx beam is determined based on one or more measurements that the WTRU may perform on a DL RS received in the first DL RS resource (e.g., in one or more instances of the first DL RS resource) in the respective SB (e.g., using the part of the first DL resource that is in the respective SB).

For each of the at least one SBs associated with the first DL resource, the WTRU may associate the determined SB-based Rx beam with the TCI state of the plurality of TCI states that corresponds to the first DL RS resource and the SBT of the respective SB.

For example, for the SB with SBT 1, the WTRU may associate the determined SB-based Rx beam with TCI state 1 (DL RS resource 1, SBT 1).

The WTRU may receive an indication of (e.g., indicating to use) a first TCI-state of the plurality of TCI states that is associated with the first DL RS resource and at least a first SBT of the one or more SBTs associated with the first DL RS resource.

In an example, based on the indication of the first TCI-state, the WTRU may receive a DL signal and/or channel (e.g., a PDCCH and/or a PDSCH etc.) scheduled on the SB associated with the first SBT using the SB-based Rx beam the WTRU associated with the first TCI state.

In an example, based on the indication of the first TCI-state, the WTRU may transmit a UL signal and/or channel (e.g., a physical uplink control channel (PUCCH), a physical uplink shared channel (PUSCH), a sounding reference signal (SRS) etc.) scheduled on the SB associated with the first SBT by using a spatial filter determined based on the SB-based Rx beam the WTRU associated with the first TCI state.

As used herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’.

A symbol ‘/’ (e.g., forward slash) may be used herein to represent ‘and/or’, where for example, ‘A/B’ may imply ‘A and/or B’.

Herein, the terms prediction and estimation may be used interchangeably, but still consistent with this disclosure.

Herein, the terms candidate cell, neighbor cell, and target cell may be used interchangeably, but still consistent with this disclosure.

Herein, the terms source cell, current cell, and serving cell may be used interchangeably, but still consistent with this disclosure.

A WTRU may transmit or receive a physical channel or reference signal according to at least one spatial domain filter. The term “beam” may be used to refer to a spatial domain filter.

The WTRU may transmit a physical channel and/or signal using the same spatial domain filter as the spatial domain filter used for receiving an RS (such as the CSI-RS) and/or a synchronization signal SS block (SSB). The WTRU transmission may be referred to as “target”, and the received RS and/or SS block may be referred to as “reference” or “source”. In such case, the WTRU may be said to transmit the target physical channel and/or signal according to a spatial relation with a reference to such RS and/or SS block.

The WTRU may transmit a first physical channel and/or signal according to the same spatial domain filter as the spatial domain filter used for transmitting a second physical channel and/or signal. The first and second transmissions may be referred to as “target” and “reference” (or “source”), respectively. In such case, the WTRU may be said to transmit the first (target) physical channel and/or signal according to a spatial relation with a reference to the second (reference) physical channel and/or signal.

A spatial relation may be implicit, configured by radio resource control (RRC) and/or signaled by media access (MAC) control element (CE) (MAC CE) or downlink control information (DCI). For example, a WTRU may implicitly transmit a PUSCH and a DM-RS of the PUSCH according to the same spatial domain filter as an SRS indicated by an SRS resource indicator (SRI) indicated in the DCI or configured by the RRC. In another example, a spatial relation may be configured by the RRC for the SRI or signaled by the MAC CE for a PUCCH. Such spatial relation may also be referred to as a “beam indication”.

The WTRU may receive a first (target) downlink channel and/or signal according to the same spatial domain filter and/or spatial reception parameter as a second (reference) downlink channel or signal. For example, such association may exist between a physical channel such as a PDCCH or a PDSCH and its respective DM-RS. At least when the first and second signals are reference signals, such association may exist when the WTRU is configured with a QCL assumption type D between one or more corresponding antenna ports. Such association may be configured as a TCI state. The WTRU may be indicated an association between a CSI-RS or a SS block and a DM-RS by an index to a set of TCI states configured by a RRC and/or signaled by a MAC CE. Such indication may also be referred to as a “beam indication”.

A WTRU may receive one or more TCI related configurations, e.g., comprising a plurality of TCI-states (e.g., an RRC-configured pool of TCI-states (e.g., as unified TCI framework), ‘TCI-State’ IE, ‘TCI-UL-State’ IE, ‘spatialRelationInfo’ IE, etc.). A TCI-state of the plurality of TCI-states may be associated (or comprised) with at least one of QCL-info #1, QCL-info #2, additionalPCI, pathloss RS (PLRS)-ID, UL-PC, timing advance group (TAG)-ID, where QCL-info #1 (or QCL-info #2) may comprise a cell-ID (e.g., serving-cell index), a BWP-ID, a RS (e.g., CSI-RS, SSB-index), and/or a QCL-type which may be one of typeA, typeB, typeC, typeD. In an example, the PLRS-ID may be for pathloss estimation for determining a UL transmission power when a UL transmission is based on a TCI-state that is associated with the PLRS-ID. In an example, the UL-PC (e.g., UL-PC parameter set, which may comprise at least one of P0, alpha, close-loop (CL)-index, power offset, etc.) may be for determining an uplink power for an UL transmission associated with the TCI-state. In an example, the additionalPCI may be a physical cell-ID (PCID) of a neighboring (surrounding) cell that the RS (associated with the TCI-state), e.g., SSB-index (or CSI-RS) may be transmitted from, e.g., as an inter-cell beam (or RS) reference. In an example, the WTRU may apply a timing advance value (e.g., based on one or more received timing advance commands (TACs)) in association with the TAG-ID (e.g., of multiple TAG-IDs being configured) to a scheduled UL transmission.

In an example, typeA may represent {Doppler shift, Doppler spread, average delay, delay spread}.

In an example, typeB may represent {Doppler shift, Doppler spread}.

In an example, typeC may represent {Doppler shift, average delay}.

In an example, typeD may represent {Spatial Rx parameter}.

When a WTRU receives an indication and/or configuration of a TCI-state (e.g., applicable for a physical channel and/or signal) at least comprising a QCL-type (e.g., by typeA, typeB, typeC, or typeD) and an RS (e.g., an RS associated with the QCL-type), the WTRU may determine (e.g., derive) at least one parameter for transmission and/or reception, representing one or more wireless channel characteristics (e.g., at least one of doppler shift, doppler spread, average delay, delay spread, and/or spatial Rx parameter etc.) based on the indicated QCL-type, and apply the at least one parameter for transmission or reception of the physical channel and/or signal.

A unified TCI (e.g., a common TCI, a common beam, a common RS, etc.) may refer to a beam and/or RS to be (simultaneously) used for multiple physical channels and/or signals. The term “TCI” may at least comprise a TCI state that includes at least one source RS to provide a reference (e.g., a WTRU assumption) for determining a QCL and/or a spatial filter.

In an example, the WTRU may receive (e.g., from a gNB) an indication of a first unified TCI to be used and/or applied for both a downlink control channel (PDCCH) and a downlink shared channel (PDSCH) (e.g., and a downlink RS). The one or more source reference signals in the first unified TCI may provide common QCL information at least for WTRU-dedicated reception on the PDSCH and all (or subset of) CORESETs in a CC. In an example, the WTRU may receive (e.g., from the gNB) an indication of a second unified TCI to be used and/or applied for both a PUCCH and a PUSCH (e.g., and an uplink RS). The one or more source reference signals in the second unified TCI may provide a reference for determining one or more common UL TX spatial filters at least for dynamic-grant and/or configured-grant based PUSCH and all (or subset of) dedicated PUCCH resources in a CC.

The WTRU may be configured with a first mode for unified TCI (e.g., SeparateDLULTCI mode, a parameter of ‘unifiedTCI-State Type’ set to ‘separate’) where an indicated unified TCI (e.g., the first unified TCI or the second unified TCI) may be applicable for either downlink (e.g., based on the first unified TCI) or uplink (e.g., based on the second unified TCI).

In an example, a WTRU may receive (e.g., from a base station (BS), agNB, and/or a transmission and reception point (TRP), etc.) an indication of a second unified TCI to be used and/or applied commonly for a PDCCH, a PDSCH, a PUCCH, and a PUSCH (and a DL RS and/or a UL RS).

The WTRU may be configured with a second mode for unified TCI (e.g., JointTCI mode, a parameter of ‘unifiedTCI-State Type’ set to ‘joint’) where an indicated unified TCI (e.g., the third unified TCI) may be applicable for both downlink and uplink (e.g., based on the third unified TCI).

The WTRU may determine a TCI state applicable to a transmission or reception by first determining a unified TCI state instance (e.g., TCI-state group, a group of TCI-states, and/or a set of activated TCI-states etc.) applicable to this transmission or reception, then determining a TCI state corresponding to the unified TCI state instance. A transmission may consist of at least a PUCCH, a PUSCH, and/or a SRS etc. A reception may include at least a PDCCH, a PDSCH, and/or a CSI-RS etc. A unified TCI state instance may also be referred to a TCI state group, a TCI state process, a unified TCI pool, a group of TCI states, a set of time-domain instances, stamps, slots, and/or symbols etc., and/or a set of frequency-domain instances, resource blocks (RBs), and/or subbands, etc. A unified TCI state instance may be equivalent and/or identified to a coreset pool identity (e.g., CORESETPoolIndex, a TRP indicator, and/or the like).

As used herein, the unified TCI may be interchangeably used with one or more of unified TCI-states, unified TCI instance, TCI, and/or TCI-state etc., but still consistent with this disclosure.

The WTRU may be configured with a plurality of TCI states, e.g., one or more unified TCI (UTCI) states, each applicable for multiple channels and/or signals. The multiple channels and/or signals may be configured to the WTRU (or pre-determined or defined), e.g., in a form of a list, by a higher-layer signaling (e.g., a RRC and/or a MAC-CE) which may comprise at least one of following (e.g., as a combination): one or more CORESETs; one or more PDCCH candidates; one or more search spaces; one or more PDSCHs (e.g., PDSCH occasions, configurations, and/or instances, etc.); one or more RSs (e.g., one or more channel state information reference signals (CSI-RSs), demodulation reference signals (DMRSs), synchronization signal block (SSB) indexes, positioning reference signals (PRSs), phase tracking reference signal (PTRSs), and/or sounding reference signals (SRSs) etc.); one or more physical uplink shared channels (PUSCHs) (e.g., one or more PUSCH occasions, configurations, and/or instances, etc.); one or more physical uplink control channel (PUCCH) resources (e.g., PUCCH resource sets and/or groups); one or more physical random access channel (PRACH) occasions, resources, and/or one or more reference signals (RSs) etc., for example.

The plurality of TCI states may be configured via an RRC signaling (e.g., and/or via a media access control (MAC) Control Element (MAC-CE) signaling, indication or activation). The WTRU may receive, e.g., via the MAC-CE or a separate signaling, an information content comprising mapping between one or more codepoints of a downlink control information (DCI) field (e.g., TCI field, and/or TCI selection field etc.) and at least one TCI state of the plurality of TCI states. The WTRU may receive a DCI comprising the DCI field. The WTRU may be indicated with one or more TCI states, of the plurality of TCI states, mapped to a codepoint of the one or more codepoints of the DCI field, where each of the one or more TCI states is applicable after a time duration determined based on a beam application time (BAT) parameter.

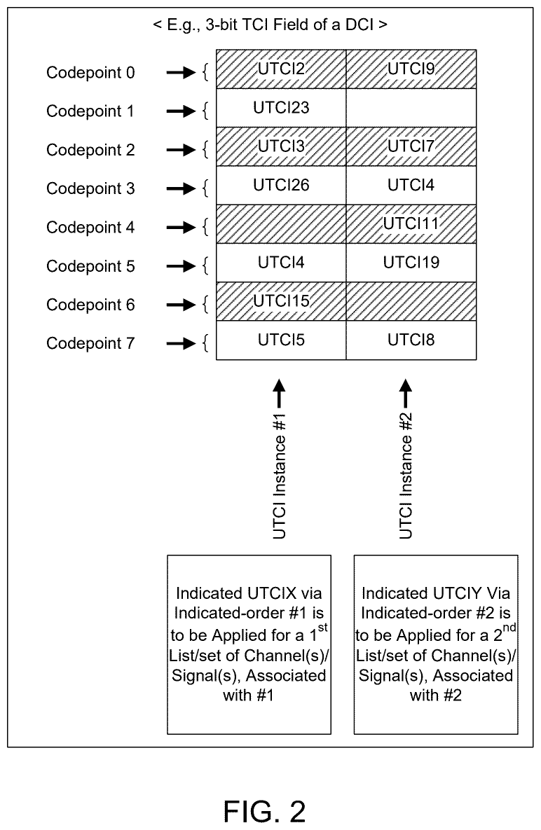

Referring now to FIG. 2, an example of a DCI field (e.g., TCI field) of a DCI for unified TCI-state indication is shown according to one or more embodiments.

FIG. 2 illustrates an example of the DCI field (e.g., TCI field) of a DCI for unified TCI-state indications. The WTRU may receive the mapping between a codepoint (of the DCI field) and one or more TCI states, illustrated in FIG. 2, e.g., via a MAC-CE signaling. For example, Codepoint 2 is mapped to {UTCI3, UTCI7}, where the WTRU may apply at least one of {UTCI3, UTCI7} to the multiple channels and/or signals, e.g., based on a list of the multiple channels and/or signals configurable by a higher-layer signaling from a gNB. In an example, the list of the multiple channels and/or signals may be given per UTCI instance (e.g., TCI-state group, a group of TCI-states, and/or a set of activated TCI-states etc.), where the UTCI instance may correspond to each column of the mapping table, illustrated in FIG. 2, between a codepoint and the one or more TCI states.

As used herein, a TRP (e.g., transmission and reception point) may be interchangeably used with one or more of transmission point (TP), reception point (RP), radio remote head (RRH), distributed antenna (DA), base station (BS), a sector (of a BS), and a cell (e.g., a geographical cell area served by a BS), but still consistent with this disclosure. As used herein, Multi-TRP may be interchangeably used with one or more of MTRP, M-TRP, and multiple TRPs, but still consistent with this disclosure.

A WTRU may be configured with (and/or may receive configuration of) one or more TRPs to which the WTRU may transmit and/or from which the WTRU may receive. The WTRU may be configured with one or more TRPs for one or more cells. A cell may be a serving cell, secondary cell.

A WTRU may be configured with at least one RS for the purpose of channel measurement. This RS may be denoted as a channel measurement resource (CMR) and may comprise a CSI-RS, SSB, and/or other downlink RS transmitted from the TRP to a WTRU. A CMR may be configured and/or associated with a TCI state. A WTRU may be configured with a CMR group where one or more CMRs transmitted from the same TRP may be configured. Each group may be identified by a CMR group index (e.g. group 1). A WTRU may be configured with one CMR group per TRP, and the WTRU may receive a linkage between one CMR group index and another CMR group index, or between one RS index from one CMR group and another RS index from another group etc., for example.

A WTRU may be configured with (and/or receive configuration of) one or more pathloss (PL) reference groups (e.g., sets) and/or one or more SRS groups, SRS resource indicator (SRI) and/or SRS resource sets etc., for example.

A PL reference group may correspond to or may be associated with a TRP. A PL reference group may include, identify, correspond to or be associated with one or more TCI states, SRIs, reference signal sets (e.g. CSI-RS set, SRI sets), control resource set (CORESET) index, and or reference signals (e.g. CSI-RS, SSB) etc., for example.

A WTRU may receive a configuration (e.g., any configuration described herein). The configuration may be received from a gNB or TRP. For example, the WTRU may receive configuration of one or more TRPs, one or more PL reference groups and/or one or more SRI sets etc., for example. A WTRU may implicitly determine an association between a RS set and/or group and a TRP. For example, if the WTRU is configured with two SRS resource sets, then the WTRU may determine to transmit to TRP1 with SRS in the first resource set, and to TRP2 with SRS in the second resource set. The configuration may be via RRC signaling.

In the examples and embodiments described herein, TRP, PL reference group, SRI group, and SRI set may be used interchangeably. The terms set and group may be used interchangeably herein.

A WTRU may report a subset of channel state information (CSI) components, where CSI components may correspond to at least a CSI-RS resource indicator (CRI), a SSB resource indicator (SSBRI), an indication of a panel used for reception at the WTRU (such as a panel identity or group identity), measurements such as layer 1 reference signal received power (L1-RSRP), layer 1 signal-to-interference-plus-noise ratio (L1-SINR) taken from SSB and/or CSI-RS (e.g. cri-RSRP, cri-SINR, ssb-Index-RSRP, ssb-Index-SINR), and other channel state information such as at least rank indicator (RI), channel quality indicator (CQI), precoding matrix indicator (PMI), layer index (LI), and/or the like.

In the following, a property of a grant or assignment may include at least one of the following: a frequency allocation; an aspect of time allocation, such as a duration; a priority; a modulation and coding scheme; a transport block size; a number of spatial layers; a number of transport blocks; a TCI state, CRI or SRI; a number of repetitions; whether the repetition scheme is Type A or Type B; whether the grant is a configured grant type 1, type 2 or a dynamic grant; whether the assignment is a dynamic assignment or a semi-persistent scheduling (configured) assignment; a configured grant index or a semi-persistent assignment index; a periodicity of a configured grant or assignment; a channel access priority class (CAPC); any parameter provided in a DCI, by MAC or by RRC for the scheduling the grant or assignment etc., for example.

In the following, an indication by DCI may include at least one of the following: an explicit indication by a DCI field or by radio network temporary identifier (RNTI) used to mask cyclic redundancy check (CRC) of the PDCCH; or an implicit indication by a property such as DCI format, DCI size, Coreset or search space, aggregation level, first resource element of the received DCI (e.g., index of first Control Channel Element (CCE), where the mapping between the property and the value may be signaled by RRC and/or MAC etc., for example.

As used herein, a signal may be interchangeably used with one or more of following: sounding reference signal (SRS); channel state information-reference signal (CSI-RS); demodulation reference signal (DM-RS); phase tracking reference signal (PT-RS); synchronization signal block (SSB), but still consistent with this disclosure.

As used herein, a channel may be interchangeably used with one or more of following: physical downlink control channel (PDCCH); physical downlink shared channel (PDSCH); Physical uplink control channel (PUCCH); physical uplink shared channel (PUSCH); physical random access channel (PRACH) etc., but still consistent with this disclosure.

As used herein, downlink reception may be used interchangeably with Rx occasion, PDCCH, PDSCH, SSB reception, but still consistent with this disclosure.

As used herein, uplink transmission may be used interchangeably with Tx occasion, PUCCH, PUSCH, PRACH, SRS transmission, but still consistent with this disclosure.

As used herein, RS may be interchangeably used with one or more of RS resource, RS resource set, RS port and RS port group, but still consistent with this disclosure.

As used herein, RS may be interchangeably used with one or more of SSB, CSI-RS, SRS and DM-RS, but still consistent with this disclosure.

As used herein, time instance may be interchangeably used with slot, symbol, subframe, but still consistent with this disclosure.

As used herein, UTCI may be interchangeably used with TCI, UTCI state, TCI state, but still consistent with this disclosure.

In an embodiment, one or more methods for frequency-dependent transmission and reception are discussed.

In a frequency-dependent beam measurement and/or reporting and associated TCI-state indication method, a WTRU may receive configuration of a plurality of TCI-states and a plurality of DL RS (e.g., CSI-RS and/or SSB etc.) resources, where a DL RS resource (e.g., each or any DL resource) of the plurality of DL RS resources may be associated with at least one of configuration parameters or properties.

In an example, a DL RS resource may be associated with an indication that the DL RS resource is applicable for frequency-dependent (e.g., JPTA based) beam measurement (BM) and reporting, where a part (e.g. group of PRBs, and/or set of time units) of the DL RS resource may correspond to a frequency component (e.g., subband, group of PRBs, etc.) of one or more frequency components of the configured band (e.g., bandwidth, frequency resource assignment) of the DL RS resource.

In an example, a DL RS resource may be associated with information indicating a number of subbands (SBs) associated with the DL RS resource, each corresponding to a subband tag (SBT) ID, where a subband may correspond to a set of PRBs. In an example, the size of each SB may be equal to the bandwidth of the DL RS resource divided by the number of SBs. In another example, a size of each SB may be, e.g., separately, independently, configured by the network.

In an example, a DL RS resource may be associated with information on a set of RS ports for each SB or SBT. In an example, the DL RS resource may comprise K antenna ports, where a first K1 port(s) may be mapped to a first SB, a second K2 port(s) may be mapped to a second SB, and so on, for which K1+K2+ . . . =K.

In an example, a DL RS resource may be associated with information on a quasi co-location (QCL)-linked RS, e.g., a source QCL RS, of the DL RS resource, where the QCL-linked RS may be an SSB and/or a tracking RS (TRS).

In an example, a DL RS resource may be associated with information on how to measure the DL RS resource and how to report corresponding measurement results, e.g., “reportQuantity”, whether to use a fixed Rx beam across SBs to find a preferred Tx beam (BM Procedure 2; P2), whether to sweep Rx beams across SBs with assuming a fixed Tx beam (BM P3), whether to report for joint Tx/Rx beam determination or refinement (BM P1), etc.

In an example, a DL RS resource may be associated with information related to whether the information on SBs, e.g., SB size of each SB, # of SBs of the DL RS resource, and/or whether a selection of BM procedure(s) can be changed or updated by a dynamic signaling (e.g., via a MAC-CE and/or DCI).

The WTRU may receive configuration of the plurality of TCI-states, where each of one or more TCI-states of the plurality of TCI-states may be, respectively, associated with at least one SBT (or SB) and a DL RS resource of the plurality of DL RS resources.

In an example, TCI-state 1 may be associated with {DL RS resource 1, SBT 1}.

In an example, TCI-state 2 may be associated with {DL RS resource 1, SBT 2}.

In an example, TCI-state 3 may be associated with {DL RS resource 1, SBT 3, SBT 4}.

In an example, TCI-state 4 may be associated with {DL RS resource 2, SBT 1}.

In an example, a TCI-state that is associated with at least one SBT (or SB) may represent a narrower beam within (or across) the at least one SBT (or SB). A TCI-state that is not associated with any SBT (or SB) may represent a wider beam across all (or a set of) SBTs (or SBs).

The WTRU may measure the QCL-linked RS (e.g., the source QCL RS such as the SSB and/or TRS) associated with a first DL RS resource of the plurality of DL RS resources, and may determine a first Rx beam (e.g., spatial-domain filter, representing a wider beam) to be used for measuring the first DL RS resource across one or more SBs.

The WTRU may perform, e.g., on condition that the BM P2 is indicated, multiple (separate) measurements on the first DL RS resource, where each measurement of the multiple measurements may be conducted for an SB (e.g., a different SB) of the SBs configured for the first DL RS resource. In an example, each measurement may be performed using the first Rx beam (e.g., an Rx beam that the WTRU commonly uses for the multiple measurements, where the Rx beam may be determined based on one or more configuration parameters associated with the first DL RS resource such as the QCL-linked RS). The WTRU may perform a measurement for each SB of the configured SBs for the first DL RS resource.

The WTRU may (be configured to) select one or more SBs of the measured SBs based on a configured measurement metric (e.g., layer1 (L1)-RSRP, L1-SINR, channel quality indicator (CQI), according to a configured parameter such as reportQuantity) and one or more thresholds (e.g., configured or indicated). For example, the WTRU may select the SBs for which the corresponding measurement exceeds the thresholds. The WTRU may report one or more SBTs (e.g., the one or more SBTs corresponding to the one or more selected SBs) and, optionally (e.g., if configured), one or more determined measurement metrics corresponding to the one or more SBTs, where the reporting may (e.g., explicitly or implicitly) include a request for the WTRU to perform Rx beam sweeping (e.g., P3). In an example, the reporting may not include a request for performing Rx beam sweeping (e.g., P3), where the WTRU may already determine a (proper) Rx beam to be used for a selected SB(s), e.g., an Rx beam based on (e.g., same as) the first Rx beam, or an Rx beam pre-associated (e.g., based on a configuration and/or indication or a rule) with the first Rx beam, and so on. In an example, the reporting may include a request for performing Rx beam sweeping (e.g., P3), where the WTRU may need to find a preferred (narrow) beam for a selected SB(s), e.g., based on the capability reporting of the WTRU, and/or determination based on a rule and/or a condition (e.g., a function with one or more thresholds) that the first Rx beam is not applicable to be used for the one or more selected SBs.

The WTRU may (be configured to) determine an SB-based Rx beam for at least one of the SBs associated with the first DL RS resource, e.g., on condition that the Rx beam sweeping (e.g., P3) is indicated and/or granted, e.g., in response to the request by the WTRU. In an example, the WTRU may determine an SB-based Rx beam for each of the selected one or more SBs. In an example, the WTRU may receive an indication for performing a Rx beam sweeping, e.g., based on configurations of BM P3 (or P1 if joint Tx and Rx beam sweeping procedure is configured and/or enabled), by measuring the first DL RS resource within (e.g. only) the one or more selected SBs, over multiple repeated time (e.g., and/or frequency) occasions, e.g., given based on configuration for the P3 or P1. In an example, information on the multiple repeated time occasions may be provided by (or associated with) the indication to the WTRU, e.g., via the DCI and/or the MAC-CE, where the WTRU may assume the Tx beam of the first DL RS resource remains unchanged across the multiple repeated occasions, e.g., for the WTRU to conduct Rx beam sweeping over the multiple repeated occasions. In an example, each SB-based Rx beam may be determined based on the one or more measurements the WTRU performs on a DL RS (e.g., a DL RS part) received in the first DL RS resource (e.g., in one or more instances of the first DL RS resource) in the respective SB (e.g., using the part of the first DL resource that is in the respective SB). Based on the Rx beam sweeping, the WTRU may determine an SB-based Rx beam (or a second Rx beam), e.g., spatial-domain filter, representing a narrower beam that is optimized for each of the at least one SBs (e.g., each of the one or more selected SBs). In an example, the beam sweeping may use one or more beams (e.g., narrow beams) with a direction that is the same as, or similar to (e.g., associated with), that of the first Rx beam.

For each of the at least one SBs associated with the first DL RS resource, the WTRU may (be configured to) associate the determined SB-based Rx beam with the TCI state of the plurality of TCI states that corresponds to the first DL RS resource and the SBT of the respective SB. In an example, for the SB with SBT 1, the WTRU may associate the determined SB-based Rx beam with TCI state 1 (DL RS resource 1, SBT 1). In an example, for the SB with SBT 3, the WTRU may associate the determined SB-based Rx beam with TCI state 1 (DL RS resource 1, SBT 3), e.g., if a TCI state update mechanism is enabled and/or indicated, or associate the determined SB-based Rx beam with TCI state X (DL RS resource 1, SBT 3) such as X=3 or other index that corresponds to (DL RS resource 1, SBT 3), and so on. In an example, a TCI-codepoint (activated by the MAC-CE) in a TCI field of a DCI may include a subband tag (SBT) information, which may enable dynamically updating SBT information for a configured TCI state.

The WTRU may receive an indication of (e.g., indicating to use) a first TCI-state of the plurality of TCI states that is associated with the first DL RS resource and at least a first SBT of the SBTs associated with the first DL RS resource. Based on the indication of the first TCI-state, the WTRU may receive a DL signal or channel (e.g., a PDCCH and/or a PDSCH etc.) scheduled on the SB associated with the first SBT using the SB-based Rx beam the WTRU associated with the first TCI state. The WTRU may transmit a UL signal or channel (e.g., a PUCCH, a PUSCH, and/or a SRS etc.) scheduled on the SB associated with the first SBT by using a spatial filter determined based on the SB-based Rx beam the WTRU associated with the first TCI state.

In an embodiment, an example method of frequency-dependent transmissions and receptions is performed based on JPTA operation.

In this section, an example method for generating multiple beams (e.g., multiple analogue beams) each applicable to be used for a frequency-dependent transmissions and/or receptions is described, which may be based on JPTA, true time delay (TTD), and/or any possible different way for generating more than one beam directions (e.g., analogue beams, analog/digital hybrid beams, spatial-domain filters, and/or spatial-domain Tx/Rx parameters etc.), e.g., across different frequency resources (e.g., subbands, bands, carriers, BWPs, RB groups, and/or RBs, etc.), simultaneously, at a (given) time.

In a fully analog configuration, an antenna array including multiple antenna elements is capable of generating a single analog beam with a desired angle of arrival (AoA) by transmitting copies of the signal through the different antenna elements with different time offsets with respect to each other. The multiple copies of the signal add up constructively and radiate with maximum power at a different AoA as a function of the time offsets. If no time offsets are applied, the signal radiates in the boresight direction of the antenna array with maximum power. In an example, this may be accomplished through a phased array where the multiple copies are transmitted with different phase offsets with respect to each other. The phased array approach results in a simpler and more cost-effective implementation to achieve the required AoA. However, for a given bandwidth W, the phased array approach can only generate a single main AoA over all frequencies in W. In order to probe the channel over K different AoAs, one AoA is generated per time slot, and K time slots are needed to transmit the K AoAs. This approach may be time consuming as K grows, and requires the WTRU to be turned on for measurement and/or reporting for the K time slots. Moreover, another issue arises when W is larger than the carrier frequency f_{c}. It can be shown [1] that the

$$AoA , θ ( f ) = {sin}^{- 1} ( \frac{{f}_{c}}{f} \frac{ΔΦ}{π} ) ,$$

is a function of the frequency f and of the inter-antenna element phase shift Δφ to achieve the desired AoA at θ(f_{c}). This issue is described as the beam squint effect since the actual AoA, θ(f), drifts away from the desired AoA, θ(f_{c}), over the bandwidth W.

Further, there may be one or more other methods to enable the transmitter to generate the K AoAs over a single time slot, where each AoA is generated over a subset of frequencies from W. Multiple different implementations may achieve this by using a combination of TTDs and phase shifters. One such proposed implementation in the literature is the JPTA. To do so, a set of time delays τᵢ, i=1: N, and phase shifts φⱼ, j=1:M, are applied to the M antenna elements. A signal may be split into N copies where the i′th copy is delayed by τᵢ, and the N copies are connected to the M antenna elements through a connection matrix P (e.g., the delayed signal i is scaled with some factor Pᵢⱼ and transmitted over antenna element j). The signal may be generated using a single RF chain that connects to all antenna elements.

Alternatively and/or additionally, subarray partitioning may be used where multiple RF chains are used, and each RF chain may connect to a subset of antenna elements. With the TTD implementation, the transmitter may select the τᵢ and o; to generate a frequency-dependent analog beam, where K different AoAs may be generated per time slot, and each of the K AoAs achieves its maximum power in a different frequency (e.g., subcarrier, RB, SB). For example, the τᵢ and @; may be chosen to achieve a constant AoA that doesn't drift over the bandwidth (e.g., θ(f)=θ(f_{c}) for all f) which compensates for the beam squint effect. Alternatively and/or additionally, the choice of τᵢ and φⱼ can determine the number of different AoAs K for efficient beam sweeping in a single slot. For network energy savings or low power WTRUs, the set of values may be optimized to generate K AoAs over a subset of frequencies from W by turning off some frequencies. The WTRU may only be required to measure and/or report a subset of frequencies from W for the K AoAs. The power from the turned off frequencies may be reallocated to the subset of frequencies where the K AoAs are transmitted to maximize the power per AoA (e.g., frequency and/or frequency component etc.). In an example, multiple possible implementations may be considered to enable an antenna array which can dynamically or semi-statically generate the set of τᵢ and φⱼ values. The set of τᵢ and φⱼ used by the transmitter may be explicitly indicated to the receiver (e.g., via a DCI and/or a MAC-CE). For example, multiple sets may be configured, and the WTRU may be indicated one of the configured sets. Alternatively and/or additionally, the WTRU may be explicitly indicated the quantized values of τᵢ and φⱼ. Alternatively and/or additionally, the set of τᵢ and φⱼ may be implicitly indicated and/or configured at the WTRU through the configuration of one or more RS and/or TCI states with one or more frequency-dependent components, where such methods to enable frequency-dependent analog beamforming are described in the disclosure.

In an embodiment, examples of one or more synchronization signals associated with frequency-dependent transmissions and WTRU reporting behaviors include that in a JPTA-based transmission (or any other method for the frequency-dependent transmissions), the scheduled transmission band W may be divided into K subband, where each subband represents a group of frequency resources, e.g., subcarriers, RBs, etc. The K configured subbands may be of an equal size. In an embodiment, each of the K subbands is associated with a different beam that are synthesized for a simultaneous scheduled transmission.

In an example, each subband may be utilized for transmission of cell-specific signals, e.g., synchronization signals, broadcast signal, e.g., PSS, SSB, etc., where the configured cell-specific signal is transmitted using different set of frequency resources associated with different beams. For example, an SSB burst (e.g., SSB burst signals) may be synthesized by transmission of different SSBs on different subbands, each assigned with a different transmission beam.

In an example, each subband may be utilized for transmission of scheduled data, e.g., PDSCH and/or PUSCH etc., where the scheduled data transmission may be transmitted using different set of frequency resources associated with different transmission beams.

In an embodiment, each subband may be utilized for transmission of configured reference signal resources, e.g., CSI-RS, SRS, and/or phase-tracking RS (PTRS), etc., where the configured reference signal may be transmitted using different set of frequency resources associated with different transmission beams. The configured reference signal resources associated with each subband may be associated with a same or different reference signal resource set, where a reference resource set includes one or more reference resources that may share one or more signal attributes, e.g., number of ports, and/or time pattern, etc.

In an embodiment, each subband may be utilized for transmission of control information, e.g., PDCCH, PUCCH, etc., where the control information payload, e.g., DCI, UCI, etc., may be transmitted using different set of frequency resources associated with different transmission beams.

In an example, for PDCCH reception, more than one search space may be configured where each search space may be associated to at least one subband (e.g., a JPTA subband). A WTRU may be configured with a common search space, from which, the WTRU may determine its associated subband (e.g., the JPTA subband) that may contain the WTRU-specific search space. WTRU may determine the beam associated to the subband based on a configuration, or from decoding of a group common DCI.

In an example, each subband may be utilized for transmission of a same random access request signal, e.g., PRACH. In an example, a WTRU may send a same preamble using more than one subband (e.g., a JPTA subband) where each subband is associated with a different beam. In an example, to minimize collision probability in Msg2, the WTRU may use a different preamble, from the set of configured preambles, per subband. The association of preambles to subbands may be configured, e.g., WTRU-specific, or may be randomly selected by WTRU. Then, once WTRU receives a random access response (e.g., RAR, Msg2), in addition to the preamble index, it may also receive an index associated to the subband from which the preamble is detected.

In a JPTA-based transmission (or any other method for the frequency-dependent transmissions) (e.g., QCL source, source-QCL RS, etc.) the WTRU may determine the receive spatial filter. In case of time domain repetition, a WTRU may be configured with more than one RS as the source for determination of the receive spatial filter.

In case of the latter, K different payloads are transmitted with K different beams.

In an embodiment, each of K payloads may be associated with a different level of priority. In an embodiment, a WTRU may be configured with at least one RS as the source for determining the receive spatial filter, where one of the configured RSs is the RS corresponding to the beam used for transmission of the payload with the highest priority.

Alternatively and/or additionally, if a WTRU has indicated its capability for a JPTA-based reception, the WTRU may receive and process each payload using the RS corresponding to the subband.

For a JPTA-based transmission (or any other method for the frequency-dependent transmissions), the hierarchy of sourcing of reference signals for measurement and demodulation may be based on size of subband (e.g., JPTA subband) grouping. For example, there may be three levels of subband grouping, e.g., L_1, L_2 and L_M, where, L_M is the lowest level of hierarchy, where the frequency-dependent (e.g., JPTA) transmission is based on K_M subbands; . . . . L_2 is the second highest level of hierarchy, where the frequency-dependent (e.g., JPTA) transmission is based on K_2 subbands. L_1 is the highest level of hierarchy, where the frequency-dependent (e.g., JPTA) transmission is based on K_1 subbands; wherein, 1≤K_1<K_2< . . . <K_M.

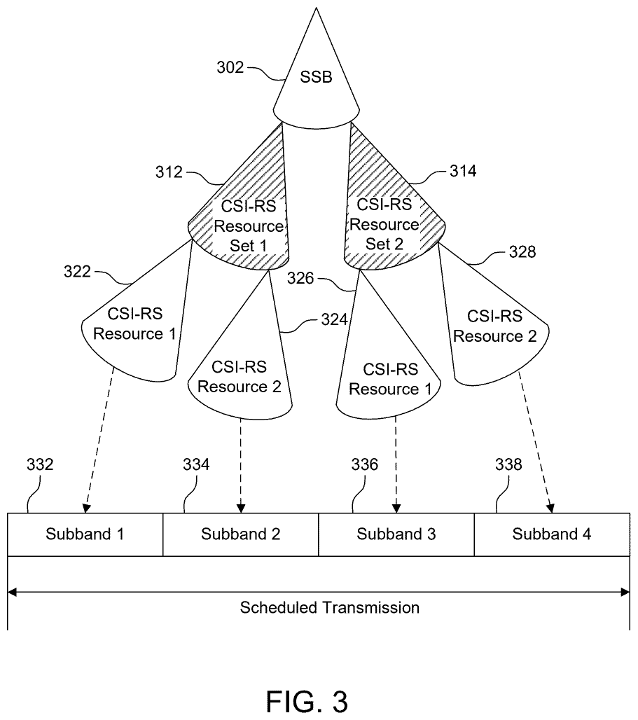

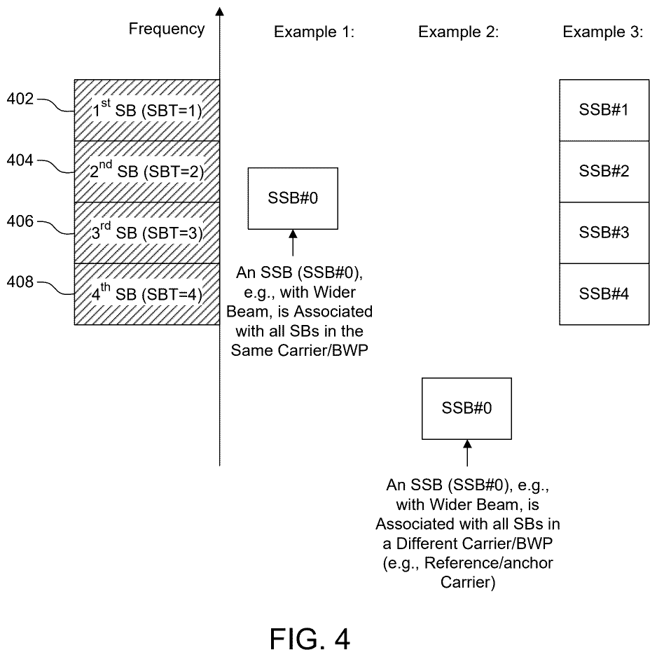

In an example, as shown in FIG. 3 (and based on FIG. 4), there may be three levels of hierarchy for reference source signal, as, L_1: One SSB, K=1; L_2: Two CSI-RS resource sets, e.g., CSI-RS set 1 and set 2, K=2, where each CSI-RS resource set is configured with two CSI-RS resources; L_3: Four CSI-RS resources in total, K=4; where each CSI-RS resource can be sourced to only one CSI-RS resource set.

Referring now to FIG. 3, an example of one or more synchronization signals associated with multiple subbands is shown according to one or more embodiments. The FIG. 3 illustrates three levels of hierarchy for a reference source signal, viz. a first level, a second level, and a third level, for example. The first level includes an SSB 302. The second level includes a first CSI-RS set 312 and a second CSI-RS set 314. The third level includes a first CSI RS resource 322 and a second CSI RS resource 324, both in the first CSI-RS set 312. The third level also includes a third CSI RS resource 326 and a fourth CSI RS resource 328, both in the second CSI-RS set 314. The first through fourth CSI RS resources 322-328 are used for a scheduled transmission in first subband 332, a second subband 334, a third subband 336, and a fourth subband 338.

Referring now to FIG. 4, an example of one or more synchronization signals associated with multiple subbands is shown according to one or more embodiments. FIG. 4 illustrates a first subband 402, a second subband 404, a third subband 406, and a fourth subband 408. In an example, an SSB with wider beam may be associated with all the subbands, viz., the first through fourth subbands 402-408 in the same carrier or bandwidth part (BWP), for example. In an example, an SSB with wider beam may be associated with all the subbands, viz., the first through fourth subbands 402-408 in different carriers or different BWPs. In an example, multiple SSBs may be associated with the first through fourth subbands 402-408. In an example, each subband may be associated with a respective SSB.

In an example, one or more SSBs may be transmitted in a bandwidth part 0, meaning a WTRU may measure and/or detect a beam index based on time domain periodicity and frequency location of a deployed cell following one or more rules of the SSB sweeping. Thus, the one or more SSBs may be considered at the top of a QCL chain. Following a detection of a SSB beam, the WTRU may read the MIB and one or more subsequent SIBs. The SIBs (for example SIB1) may contain information related to the JPTA beamforming (or any other method for the frequency-dependent transmissions), for example an SB size, and/or a number of SBTs (SB tag id) etc.

Alternatively and/or additionally, the one or more SSBs may have an equivalent TRS for the SSB based beam. The equivalent TRS may be assumed by the WTRU at the top of the QCL chain in this case. In the following description the equivalent TRS of an SSB may be used interchangeably.

Upon moving in connected mode, the WTRU may be configured with several TCI states and sub-states, that may be related to an SSB index detected by the WTRU in the initial beam pairing process. The QCL configuration may contain the top SSB index while the TCI sub-states may be related to several RS pilots (CSI-RS or TRS, for example) on each described SBT. Upon activation of such TCI state containing sub-states, the WTRU may start measuring one or more sub-states associated RS and report one or more sub-band tag related frequency-dependent (e.g., JPTA) beams. Upon reception of these measurements, the network may activate in a second step one or a sub-set of frequency-dependent (e.g., JPTA) beams through a TCI sub-state activation.

Alternatively and/or additionally, the network may activate in a single step a TCI state that contains related frequency-dependent (e.g., JPTA) beams and RS sub-set for the one or more frequency-dependent (e.g., JPTA) beams tracking.

In an example, the WTRU may be scheduled through one or more DCIs signaling the SSB based beam TCI and a sub-state SBT, and/or directly through a sub-state SBT JPTA beam or a sub-set of SBT JPTA beams.

When the WTRU is under an activated TCI that contains SBT sub-states, the WTRU may measure and report the SBT configured RS and/or TRS. The WTRU may report all the TCI related and/or one or more configured measured SBTs, and/or just the suitable ones, meaning those that are over a certain threshold.

In an example, the WTRU may use the SBT RS and/or TRS for CSI feedback, that may include the frequency-dependent (e.g., JPTA) beams measurements. In an embodiment, the CSI-RS ports of a single CSI-RS resource may be split in the frequency domain over the one or more SBs (Example 1 in FIG. 4). Alternatively and/or additionally, the WTRU may be configured with different CSI-RS resources per SBT (Example 2 in FIG. 4).

Referring now to FIG. 4, an example of a DL RS resource configuration associated with multiple subbands is shown according to one or more embodiments.

In an example, with SSB at the top of a QCL chain, the WTRU may use one or more SSB measurements for the cell radio link monitoring (e.g., instead of CSI-RS measurements each corresponding a SB). In an embodiment, a radio link failure (e.g., a second-level radio link failure on top of a legacy radio link failure based on one or more SSBs) may be declared when a CSI-RS based link quality (of the CSI-RS measurements each corresponding a SB) fails, where the WTRU may (be configured to) report information on this declared event, e.g., information on the CSI-RS, one or more SBTs, one or more quality metrics, based on (e.g., corresponding to) the declared event.

In an example, the WTRU may follow the SSB based beam management, that may include SSB related CSI-RS beam management. Thus, a beam failure may be declared only when the SSB based beam fails (e.g., instead of detecting a beam failure condition on CSI-RS measurements each corresponding a SB). In an embodiment, a beam failure (e.g., a second-level beam failure on top of a legacy beam failure based on the one or more SSBs) may be declared when a CSI-RS based beam (of the CSI-RS measurements each corresponding a SB) fails, where the WTRU may (be configured to) report information on this declared event, e.g., information on the CSI-RS, the one or more SBTs, the one or more quality metrics, based on (e.g., corresponding to) the declared event.

The PDCCH monitoring may follow the SSB wider beam since the radio link monitoring may be linked to the SSB or to a linked RS. Thus, the spatial filter to apply for the PDCCH reception may be SSB based. In an example, a spatial filter to apply for the PDCCH reception may be CSI-RS based, e.g., frequency-dependent (frequency-specific).

However, the PDSCH reception may be based on SBT spatial filter. One possibility would be to have the DCI signaled TCI sub-state for JPTA reception. If the processing time is not sufficient, the WTRU may fall back to the SSB based top TCI of the signaled JPTA sub-state.

In an example, the channel bandwidth may be split in sub-bands and each frequency-dependent (e.g., JPTA) beam may have a designated SSB, e.g., based on Example 3 of FIG. 4. This case may fit for example wide channel bandwidths, where the SSB size in frequency domain may be accommodates without a loss of measurements accuracy.

In an example, the beam detection and measurements may have to be performed in each related symbol for each defined sub-band (SB). The DL sub-band for beam detection may be fixed. The UL active bandwidth may have a different size or position in the channel bandwidth.

In an example, one or more TCI states may maintain the SSB as top QCL source. This means that CSI-RS and measurements may follow one or more defined (or configured) SBs, e.g., based on each tops QCL source of an SSB per SB.

In an example, a WTRU may be configured with a DCI or RRC to measure CSI over some sub-bands and report a CQI for each sub-band. Then, a gNB may apply a JPTA with the true time delay for each sub-band. This may increase the overhead for reporting the CQI. In some examples with a high doppler, a WTRU may be configured with high number of sub-bands to report for channel accuracy. To reduce the feedback overhead, a WTRU may determine some of the sub-bands with higher priority and report a CSI only over those sub-bands. Then, the gNB may perform an interpolation among the other sub-bands with lower priority. A WTRU may also determine a different report quantity for both sub-bands with high and low priorities. For example, a WTRU may report CQI, PMI and RI for all sub-bands with higher priority. While, a WTRU may report only CQI for the other sub-bands with lower priority.

The sub-bands that WTRU requires to report may be configured with a DCI or RRC.

The WTRU may determine a new report quantity based on a combination of the configured report quantity and Number of sub-bands.

For example, the WTRU may be configured with a threshold for the number of sub bands,

$${N}_{s u b}^{t h} < {N}_{sub} ,$$

where N_{sub} is the total number of sub bands. Then, based on this threshold, the WTRU may determine a mechanism for the report quantity including at least

$${N}_{s u b}^{t h}$$

sub-band CQI or/and PMI to report:

If WTRU is configured to report at least

$${N}_{s u b}^{t h} and {N}_{s u b}^{t h} < \frac{{N}_{s u b}}{2} ,$$

the report quantity may include sub-band CQI or/and PMI for only the even or odd sub-bands.

If the WTRU is configured to report at least

$${N}_{s u b}^{t h} and {N}_{s u b}^{t h} \geq \frac{{N}_{s u b}}{2} ,$$

the WTRU may randomly select

$${N}_{s u b}^{t h}$$

sub-bands to calculate CQI or/and PMI or the WTRU may calculate all sub-bands CQI or/and PMI for N_{sub} sub-bands and select the best

$${N}_{s u b}^{t h}$$

sub-bands for the report quantity.

In an example, the WTRU may be configured with two thresholds, one for the number of sub-bands,

$${N}_{s u b}^{t h} < {N}_{sub} ,$$

where N_{sub} is the total number of sub-bands and the other one for the maximum sub-bands distance among a per of reported sub-band

$${M}_{s u b}^{t h} .$$

Since in some scenarios there may be channel correlation among the sub-bands, the gNB requires to make sure that the report of at least

$${N}_{s u b}^{t h}$$

sub-bands that are not next to each other from given N_{sub} sub-bands. Thus, based on

$${N}_{s u b}^{t h} and {M}_{sub}^{t h} ,$$

the WTRU may determine a report quantity as follows:

In an example, the WTRU may first select

$$[ \frac{{N}_{s u b}}{{M}_{s u b}^{t h}} ]$$

sub-bands with

$${M}_{s u b}^{t h}$$

distance from

$${N}_{s u b}^{t h}$$

sub-band. Then, the WTRU may randomly select the other

$${N}_{sub} - [ \frac{{N}_{s u b}}{{M}_{s u b}^{t h}} ]$$

sub-bands from the

$${N}_{sub} - [ \frac{{N}_{s u b}}{{M}_{s u b}^{t h}} ]$$

left sub-bands.

In an example, the WTRU may first select

$$[ \frac{{N}_{s u b}}{{M}_{s u b}^{t h}} ]$$

sub bands with

$${M}_{s u b}^{t h}$$

distance from

$${N}_{s u b}^{t h}$$

sub band. Then, the WTRU may select the first

$${N}_{sub} - [ \frac{{N}_{s u b}}{{M}_{s u b}^{t h}} ]$$

sub bands rom the

$${N}_{sub} - [ \frac{{N}_{s u b}}{{M}_{s u b}^{t h}} ]$$

left sub bands.

The WTRU may receive an indication of (e.g., indicating to use) a first TCI-state, e.g., TCI state 1 (DL RS resource 1, SBT 1), of the plurality of TCI states that is associated with the first DL RS resource and at least a first SBT of the SBTs, e.g., associated with the first DL RS resource. In an embodiment, the WTRU may (be configured to) determine a default SBT that is the first SBT (based on the indication of the first TCI-state) for the WTRU to use for DL receptions and/or UL transmissions, e.g., unless indicated (or further updated) otherwise. The default SBT may imply (e.g., indicate, refer to, point to) a valid range of RBs (e.g., analogous to BWP) based on the SB with the default SBT that the WTRU uses for communications for DL and/or UL, unless indicated otherwise (or until further updated). In an example, the WTRU may determine (e.g., activate automatically) a valid resource of a DL or UL channel (e.g., CORESET, SPS-PDSCH, CG-PUSCH, etc.) based on the default SBT. For example, if a first CORESET spans in a first SB, a second CORESET spans in a second SB, and the default SBT is SBT=1, the WTRU may determine that the first CORESET is valid (on which the WTRU monitors PDCCHs) but the second CORESET is not valid (on which the WTRU stops monitoring PDCCHs). For example, if a first CG-PUSCH resource spans in a first SB, a second CG-PUSCH resource spans in a second SB, and the default SBT is SBT=1, the WTRU may determine that the first CG-PUSCH resource is valid (on which the WTRU transmits PUSCHs on occasions based on the first CG-PUSCH configuration) but the second CG-PUSCH resource is not valid (on which the WTRU stops transmitting (e.g., does not transmit) PUSCHs on occasions based on the second CG-PUSCH configuration).

In an example, the WTRU may (be configured to) apply that a frequency-domain resource assignment (FDRA), e.g., in a DCI, may be reinterpreted based on the valid range of RBs associated with an indicated SBT (e.g., the default SBT). This may provide benefits in terms of efficient frequency resource utilization and management in a large bandwidth system, e.g., virtual cell-splitting effects across the one or more SBs in frequency domain.

In an embodiment, the WTRU may receive an indication of (e.g., indicating to use) a second TCI-state, e.g., TCI state 3 (DL RS resource 1, SBT 3, SBT 4), of the plurality of TCI states that is associated with the first DL RS resource and more than one SBT of the SBTs, e.g., associated with the first DL RS resource. The WTRU may determine a default SBT (e.g., SBT 1) that is the first SBT (based on the indication of the first TCI-state, e.g., TCI state 1 (DL RS resource 1, SBT 1) for the WTRU to use for DL receptions and/or UL transmissions, e.g., unless indicated (or further updated) otherwise. The indication of the second TCI-state may satisfy the condition (e.g., as unless indicated or further updated otherwise) to not use the default SBT. The indication may (further) comprise (or be associated with) at least one of following information, including a time-domain related information, e.g., a time duration to apply the indicated second TCI-state, e.g., when to start applying and/or when to end applying (e.g., fallback to apply the default SBT).

In an example, the indication may comprise and/or be associated with information related to applicable physical channel and/or signal (or one or particular types of a physical channel or signal) to apply the indicated second TCI-state, where the applicable physical channel and/or signal (or one or particular types of a physical channel or signal) may be at least one of the following: a PUSCH (e.g., all types of PUSCH, or one or more particular types of PUSCH), e.g., a configured grant (CG)-PUSCH (or further specific to a particular Tx type, e.g., a Type-1 CG-PUSCH, a Type-2 CG-PUSCH, etc.); a dynamic grant (DG) PUSCH A PUCCH (e.g., all types of PUCCH, or one or more particular types of PUCCH), e.g., a PUCCH carrying CSI reporting contents (e.g., a PUCCH carrying a UCI); and/or a PUCCH carrying a HARQ-ACK; an SRS (e.g., all types of SRS, or one or more particular types of SRS), e.g., an SRS resource; an SRS resource set; an SRS configuration (e.g., ‘SRS-config’) that may comprise one or more SRS resource sets (or, one or more SRS resources); a group of SRS resources associated with a (e.g., same) ‘usage’ parameter, e.g., indicating at least one of {CB, NCB, BM, AS}; a PRACH (e.g., all types of PRACH, or one or more particular types of PRACH), e.g., a group of PRACHs, associated with (e.g., used for) a contention-based random access (or a contention-free random access); a group of PRACHs, associated with (e.g., used for) a 4-step RACH procedure (or a 2-step RACH procedure); a PDSCH (e.g., all types of PUSCH, or one or more particular types of PUSCH), e.g., a semi-persistent-scheduling (SPS)-PDSCH (or further specific to a particular type of SPS-PDSCH, if configured); a dynamic grant (DG) PDSCH A PDCCH (and/or CORESET) (e.g., all types of PDCCH (and/or CORESET), or one or more particular types of PDCCH (and/or CORESET)), e.g., a group of PDCCH types A group of cell-common PDCCHs (e.g., that may be associated with a cell-specific search space (set); a group of WTRU-specific PDCCHs (e.g., that may be associated with a WTRU-specific search space (set) PDCCH associated with a particular group of search spaces (or search space sets) PDCCH associated with a particular group of CORESETs (e.g., a special CORESET, CORESET #0, CORESET #0 that may be used for initial access, a CORESET that is configured as a part of beam failure recovery procedure); an CSI-RS (e.g., all types of CSI-RS, or one or more particular types of CSI-RS), e.g., an CSI-RS resource; an CSI-RS resource set; a CSI-RS configuration (e.g., ‘CSI-RS-config’) that may comprise one or more CSI-RS resource sets (or, one or more CSI-RS resources); a group of CSI-RS resources associated with a (e.g., same) particular usage, e.g., applicable for beam management, mobility management, and/or RRM, etc.; a group of CSI-RS resources for tracking (e.g., tracking RS (TRS)); a demodulation RS (DMRS) (e.g., all types of DMRS, or one or more particular types of DMRS); and/or a phase-tracking RS (PTRS) (e.g., all types of PTRS, or one or more particular types of PTRS).

Based on the received indication, the WTRU may determine a valid range of RBs (e.g., analogous to BWP) based on the indicated SBs, e.g., based on the indicated SBT 3 and SBT 4 by the TCI state 3, that the WTRU uses for communications for DL and/or UL, e.g., for the time duration based on the time-domain related information and/or the information related to applicable physical channel or signal (or one or particular types of a physical channel or signal).

In an example, the WTRU may determine (e.g., activate automatically) a valid resource of a DL or UL channel (e.g., CORESET, SPS-PDSCH, CG-PUSCH, etc.) based on the one or more SBs indicated by SBT 3 and SBT 4 of the TCI state 3. For example, if a first CORESET spans (at least) in the one or more indicated SBs, a second CORESET spans in a third SB (e.g., SBT 2), the WTRU may determine that the first CORESET is valid (on which the WTRU monitors one or more PDCCHs) but the second CORESET is not valid (on which the WTRU stops monitoring the one or more PDCCHs).

For example, if a first CG-PUSCH resource spans (at least) in the one or more indicated SBs, a second CG-PUSCH resource spans in a third SB (e.g., SBT 2), the WTRU may determine that the first CG-PUSCH resource is valid (on which the WTRU transmits one or more PUSCHs on occasions based on the first CG-PUSCH configuration) but the second CG-PUSCH resource is not valid (on which the WTRU stops transmitting (e.g., does not transmit) PUSCHs on one or more occasions based on the second CG-PUSCH configuration). The WTRU may stop applying the indicated TCI state 3, e.g., after expiry of the time duration on condition that the time-domain related information is indicated, and may start (e.g., resume) applying the default SBT. The WTRU may stop applying the indicated TCI state 3 and start applying a different TCI state Y, e.g., Y=5, TCI state 5 (DL RS resource 2, SBT 2), if the WTRU receives the different TCI state Y (Y=5), where the WTRU may determine updating the default SBT to be SBT 2 in response to receiving the TCI state 5.

In an example, the WTRU may (be configured to) apply a beam cycling across more than one SBT (e.g., along with the indication of TCI state 3 (DL RS resource 1, SBT 3, SBT 4) or any other indication (or a default operation behavior) enabling more than on SBT to apply. In an example, the WTRU may be configured (e.g., one or more symbols-specifically) to perform measurements by assuming beam cycling across the one or more SBTs (if configured or indicated), e.g., only measuring 1-port across all SBTs for the whole BWP, e.g., especially when the SBT-configuration and/or indication is not given (as a default simplified operation of BM). In an example, at least one same antenna port, e.g., only 1-port across all or multiple SBTs, may be commonly (e.g., consistently) used over the more than one SBT and used for scheduling (e.g., for DL and/or UL) for the whole bandwidth (e.g., BWP, cell, carrier). This mode of operation (based on the beam cycling) may provide benefits in terms of reduced operational complexity (due to the frequency-dependent operation) and/or improving robustness of communications (e.g., in case of high speed, high Doppler scenario where accurate beamforming per frequency component (e.g., SBT) may not be an optimal method). This mode of operation (based on the beam cycling) may be used in a specific time duration (e.g., in a specific condition for use, such as Tx/Rx repetition schemes across SBTs, etc.) while in general the WTRU may use at least one of abovementioned behaviors (e.g., based on the default SBT, based on the indicated TCI state associated with more than one SBT, and so on).

In an example, the WTRU may receive an indication that a group of SBTs may be turned off for the WTRU (for a time duration (being configured or indicated), semi-statically (until further indicated, unless indicated otherwise). This may provide benefits in terms of energy saving and/or operational complexity reduction. This behavior may be ended, e.g., if the WTRU receives further notice such as a fallback to the normal mode (e.g., previous mode of operation) without (e.g., no longer) turning off the group SBTs.

The gNB may perform downlink transmissions towards the WTRU using an analog beamformer at the transmitter. In analog beamforming, due to the constant phase response across all frequencies of the phase shifter, the antenna array is only capable of generating a single angle-of-departure (AoD) at the transmitter. However, due to the multi-path nature of the wireless channel, the signal transmitter from the transmitter propagates through different paths and arrives at the receiver of the WTRU at different time instances. The difference in time between two or more paths determines the delay spread of the wireless channel. Higher delay spread negatively affects the reception performance at the receiver, e.g., causing inter-symbol interference. At the receiver, the WTRU typically has a path finder to select the stronger paths for reception of the transmitted signal. However, ignoring certain paths for reception reduces the sum of the received electromagnetic energy, resulting in a reduced capacity of the wireless channel.

In an orthogonal frequency division multiplexing (OFDM) system, different sub-carriers are used. Each sub-carrier has a different center frequency. Due to frequency selectivity of the wireless channel, each subcarrier may experience a different phase shift and attenuation. A multi-path component with a delay τ, introduces a frequency dependent phase shift given by θ(f)=2πfτ, for example, the phase shift at frequency f₁ is θ(f₁)=2πf₁τ and the phase shift for frequency f₂ is θ(f₂)=2πf₂τ and the phase shift difference between the two on the same multi-path with delay τ is Δ(f)=2π(f₂−f₁)τ. Subcarriers dependent phase shifts may lead to destructive interference resulting in deep fading.

In an example, the WTRU may perform path selection at the subcarrier level to limit interference. For example, for a subcarrier with frequency f₁, the WTRU may select a path with delay τ₁ and for a subcarrier with frequency f₂, the WTRU may select a path with delay τ₂ such that θ(f₁)=θ(f₂) and Δ(f)=2π(f₂)τ₂−2π(f₁)τ₁=0. However, such selection may lead to using less-dominant paths or weaker paths at certain subcarriers, causing performance degradation.

Beamforming with frequency-dependent AoDs or frequency dependent delays may be used to compensate for the phase offset θ(f) at a certain frequency f. In analog beamforming, phase shifters may be jointly used with TTD elements to achieve frequency-dependent AoDs at the transmitter, where the TTD elements are used to apply frequency-dependent time delays to the antenna elements at the transmitter along with phase shifts. However, what TTD values to use depends on the operating environment that the gNB is unaware. In an example, the gNB may use a first set of TTD values when transmitting towards a WTRU. The WTRU may perform frequency dependent phase offset estimations, e.g., for a subcarrier with center frequency f₁, and for a path with delay τ, the WTRU determines θ(f₁)=2πf₁τ. The WTRU may perform frequency dependent phase offset estimations for one or more subcarriers, e.g., in a bandwidth W with N subcarriers, the WTRU may perform phase-offset estimations on a subset of the N subcarriers. The WTRU may quantize the determined phase offsets and sends it to the gNB in a CSI report. The gNB may use the reported phase offsets to compensate for the phase offsets at different subcarriers.

In an example, the WTRU may be semi-statically or dynamically (e.g., by RRC, MAC-CE, and/or DCI) (e.g., explicitly or implicitly) configured and/or indicated to determine phase offset values based on a configured and/or indicated subcarriers, resource blocks, or subbands in the configured bandwidth.

For example, the configured bandwidth has 10 subbands and the WTRU is configured to determine a phase-offset based on the even-numbered or based on the odd-numbered subbands.

In an example, the WTRU may select the subcarrier indexes for determination of the phase offset values based on the phase variations observed at different subbands of the bandwidth.

For example, a bandwidth has 4 subbands. The first two subbands in a bandwidth has the same phase variation and the next two subbands in the bandwidth has the same phase variations but different than the phase variations of the first two subbands.

The WTRU may determine two phase offset values, where the first phase offset value is associated with the first two subbands in the bandwidth and the second phase offset value is associated with the second two subbands.

The WTRU may use a quantization rule to quantize the determine phase offset values, e.g., the WTRU may use the constellation plane of a quadrature phase shift keying (QPSK) for quantizing the determined phase offset value.

The WTRU may send an indicator to indicate the phase offset values.

For example, the WTRU may send an indicator to indicate the number of phase offset values.

For example, the WTRU may send one or more indicators to indicate that the first phase offset value is associated with the first two subbands and the second offset value is associated with the remaining two subbands.

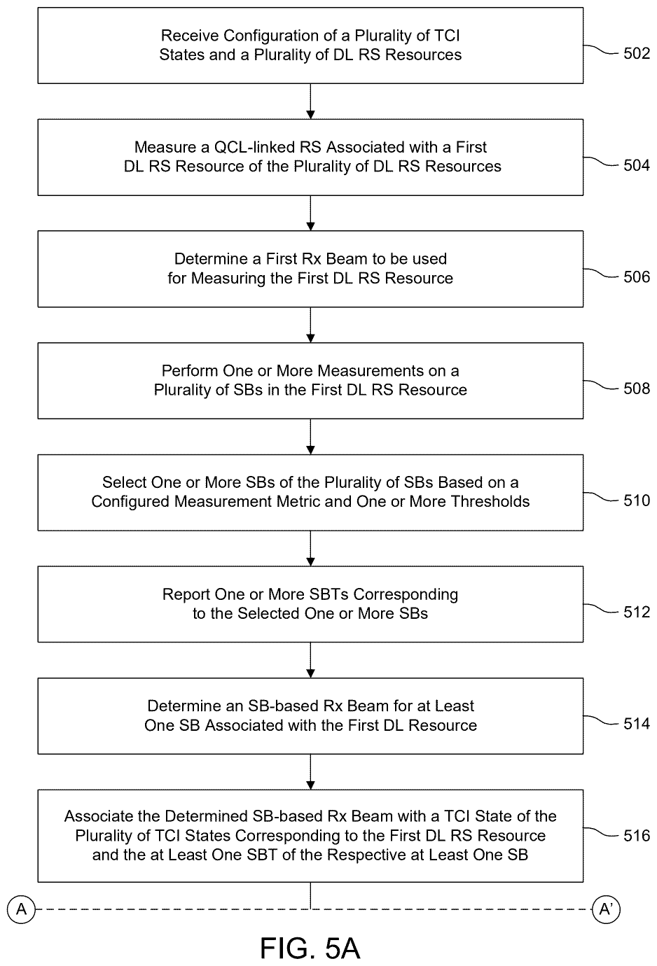

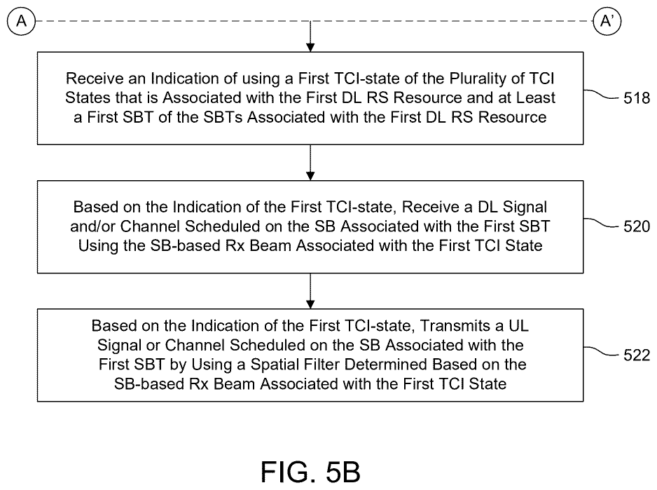

Referring now to FIGS. 5A-5B, a flowchart illustrating an example method for a frequency-dependent analog beamforming operation is shown according to one or more embodiments. The method may be performed by a WTRU.

At 502, the WTRU may receive a configuration of a plurality of TCI states and a plurality of DL RS resources. A DL RS resource (e.g., each or any DL resource) of the plurality of DL RS resources may be associated with at least one of following configuration parameters or properties: an indication that the DL RS resource is applicable for frequency-dependent (JPTA based) BM and reporting; and/or information indicating a number of SBs associated with the DL RS, each corresponding to a SBT ID. In an example, a size of each SB is equal to the bandwidth of the DL RS resource divided by the number of SBs or the size of each SB is configured by the network; and/or information on a QCL-linked RS, e.g., a source QCL RS, of the DL RS resource, where the QCL-linked RS may be an SSB and/or a TRS. Each of one or more TCI-states of the plurality of TCI-states may be, respectively, associated with at least one SBT (or SB) and a DL RS resource of the plurality of DL RS resources. In an example, a TCI-state that is associated with at least one SBT (or SB) may represent a narrower beam within (or across) the at least one SBT (or SB). In an example, a TCI-state that is not associated with any SBT (or SB) may represent a wider beam across all SBTs (or SBs).

At 504, the WTRU may measure a QCL-linked RS associated with a first DL RS resource of the plurality of DL RS resources. In an example, the QCL-linked RS may be a source QCL RS such as an SSB and/or a TRS etc.

At 506, the WTRU may determine a first Rx beam to be used for measuring the first DL RS resource. In an example, the WTRU may determine spatial-domain filter, representing a wider beam etc. to be used for measuring the first DL RS resource across SBs.

At 508, the WTRU may perform one or more measurements on a plurality of SBs in the first DL RS resource. Each measurement of the one or more measurements is conducted for an SB (e.g., a different SB) of the plurality of SBs configured for the first DL RS resource where each measurement is performed using the first Rx beam. The WTRU may perform a measurement for each SB of the plurality of SBs configured for the first DL RS resource.

At 510, the WTRU may select one or more SBs of the plurality of SBs based on a configured measurement metric and one or more thresholds. The WTRU may select one or more SBs of the measured SBs based on a configured measurement metric (e.g., layer1 (L1)-RSRP, L1-SINR, CQI, according to reportQuantity) and one or more thresholds (e.g., configured or indicated); for example, the WTRU selects the one or more SBs for which the corresponding measurement exceeds the threshold measurement.

At 512, the WTRU may report one or more SBTs corresponding to the selected one or more SBs. The WTRU may also report the determined measurement metrics corresponding to the one or more SBTs. In an example, the WTRU may request to perform beam sweeping. In an example, the WTRU may determine a default SBT from the at least one SBT. In an example, the WTRU may apply a beam cycling across the at least one SBT.

At 514, the WTRU may determine an SB-based Rx beam for at least one SB associated with the first DL resource. For example, the WTRU may determine an SB-based Rx beam for each of the selected one or more SBs. Each SB-based Rx beam is determined based on measurements the WTRU performs on a DL RS received in the first DL RS resource (e.g., in one or more instances of the first DL RS resource) in the respective SB (e.g., using the part of the first DL resource that is in the respective SB).

At 516, the WTRU may associate the determined SB-based Rx beam with a TCI state of the plurality of TCI states corresponding to the first DL RS resource and the at least one SBT of the respective at least one SB. For example, for the SB with SBT 1, the WTRU associates the determined SB-based Rx beam with TCI state 1 (DL RS resource 1, SBT 1). In an example, the subband-based Rx beam is narrower than the first Rx beam.

At 518, the WTRU may receive an indication of using a first TCI-state of the plurality of TCI states that is associated with the first DL RS resource and at least a first SBT of the SBTs associated with the first DL RS resource.

At 520, the WTRU, based on the indication of the first TCI-state, may receive a DL signal and/or channel scheduled on the SB associated with the first SBT using the SB-based Rx beam associated with the first TCI state.

At 522, the WTRU, based on the indication of the first TCI-state, may transmit a UL signal or channel scheduled on the SB associated with the first SBT by using a spatial filter determined based on the SB-based Rx beam associated with the first TCI state.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed by a wireless transmit/receive unit (WTRU), the method comprising:
receiving, from a base station, configuration information indicative of a plurality of transmission configuration indication (TCI) states and a plurality of downlink (DL) reference signal (RS) resources;
performing, using a first Rx beam, one or more measurements on a plurality of subbands (SBs) associated with a first DL RS resource of the plurality of DL RS resources;
selecting a set of SBs, from the plurality of SBs associated with the first DL RS resource, based at least on the one or more measurements;
transmitting, to the base station, a first indication of a set of subband tags (SBTs) associated with the selected set of SBs;
determining a set of subband-based Rx beams associated with the selected set of SBs;
associating the set of subband-based Rx beams to a first TCI state of the plurality of TCI states;
receiving, from the base station, a second indication indicating that the WTRU is to use the first TCI state and at least one SBT of the set of SBTs; and
communicating with the base station using at least one of the set of subband-based Rx beams associated with the first TCI state and the at least one SBT.

2. The method of claim 1, wherein the configuration information comprises one or more of:
an indication that each DL RS resource is applicable for frequency-dependent beam measurement (BM) and reporting,
an indication of one or more SBs and one or more corresponding SBTs associated with the each DL RS, or an indication of one or more quasi colocation linked (QCL-linked) RSs associated with the plurality of DL RS resources.

3. The method of claim 2, further comprising:
measuring a first QCL-linked RS of the one or more QCL-linked RSs associated with the first DL RS resource; and
determining the first Rx beam based on the measured first QCL-linked RS.

4. The method of claim 1, wherein selecting the set of SBs comprises:
comparing the one or more measurements with one or more thresholds; and
selecting the set of SBs corresponding to the one or more measurements exceeding the one or more thresholds.

5. The method of claim 1, wherein communicating with the base station comprises:
receiving, based on the second indication, at least one of: a DL signal or a DL channel scheduled on at least one SB associated with the at least one SBT.

6. The method of claim 1, wherein communicating with the base station comprises:
transmitting, based on the second indication, at least one of: an uplink (UL) signal or an UL channel scheduled on at least one SB associated with the at least one SBT.

7. The method of claim 1, wherein the first indication comprises a request to perform beam sweeping, and wherein the set of subband-based Rx beams are determined based at least on the first indication, and wherein the set of subband-based Rx beams are narrower than the first Rx beam.

8. The method of claim 1, further comprising:
determining a default SBT from the at least one SBT.

9. The method of claim 8, further comprising:
determining at least one of: a valid DL signal, a DL channel, a UL signal, or a UL channel within an SB corresponding to the default SBT.

10. The method of claim 1, further comprising:
applying a beam cycling across the set of SBTs.

11. A wireless transmit/receive unit (WTRU), comprising:
a transceiver; and
a processor, wherein the transceiver and the processor are configured to:
receive, from a base station, configuration information indicative of a plurality of transmission configuration indication (TCI) states and a plurality of downlink (DL) reference signal (RS) resources,
performing, using a first Rx beam, one or more measurements on a plurality of subbands (SBs) associated with a first DL RS resource of the plurality of DL RS resources,
selecting a set of SBs, from the plurality of SBs associated with the first DL RS resource, based at least on the one or more measurements,
transmit, to the base station, a first indication of a set of subband tags (SBTs) associated with the selected set of SBs,
determine a set of subband-based Rx beams associated with the selected set of SBs,
associate the set of subband-based Rx beams to a first TCI state of the plurality of TCI states,
receive, from the base station, a second indication indicating that the WTRU is to use the first TCI state and at least one SBT of the set of SBTs, and
communicate with the base station using at least one of the set of subband-based Rx beams associated with the first TCI state and the at least one SBT.

12. The WTRU of claim 11, wherein the configuration information comprises one or more of:
an indication that each DL RS resource is applicable for frequency-dependent beam measurement (BM) and reporting,
an indication of a set of SBs and corresponding set of SBTs associated with the each DL RS, or
an indication of one or more quasi colocation linked (QCL-linked) RSs associated with the plurality of DL RS resources.

13. The WTRU of claim 12, wherein the transceiver and the processor are configured to:
measure a first QCL-linked RS of the one or more QCL-linked RSs associated with the first DL RS resource, and
determine the first Rx beam based on the measured first QCL-linked RS.

14. The WTRU of claim 11, wherein selecting the set of SBs comprises:
comparing the one or more measurements with one or more thresholds, and
selecting the set of SBs corresponding to the one or more measurements exceeding the one or more thresholds.

15. The WTRU of claim 11, wherein communicating with the base station comprises:
receiving, based on the second indication, at least one of: a DL signal or a DL channel scheduled on at least one SB associated with the at least one SBT.

16. The WTRU of claim 11, wherein communicating with the base station comprises:
transmitting, based on the second indication, at least one of: an uplink (UL) signal or an UL channel scheduled on at least one SB associated with the at least one of the set of SBTs.

17. The WTRU of claim 11, wherein the first indication comprises a request to perform beam sweeping, and wherein the set of subband-based Rx beams are determined based at least on the first indication, and wherein the set of subband-based Rx beams are narrower than the first Rx beam.

18. The WTRU of claim 11, wherein the transceiver and the processor are further configured to:
determine a default SBT from the at least one SBT.

19. The WTRU of claim 18, wherein the transceiver and the processor are further configured to:
determine at least one of: a valid DL signal, a DL channel, a UL signal, or a UL channel within an SB corresponding to the default SBT.

20. The WTRU of claim 11, wherein the transceiver and the processor are further configured to:
applying a beam cycling across the at least one SBT.
